(19) United States
(12) Patent Application Publication
(10) Pub. No.: US 2005/0109379 A1
(43) Pub. Date: May 26, 2005

(54) Lower leg crutch

(76) Inventor: David J. Rader, Allendale, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/996,280

(22) Filed: Nov. 23, 2004

Related U.S. Application Data
(60) Provisional application No. 60/525,035, filed on Nov. 25, 2003.

(51) Int. Cl. A61H 3/02

(52) U.S. Cl. 135/68

(57) ABSTRACT

A lower leg crutch comprising a leg cradle, a leg cradle frame supporting the leg cradle and at least one leg member. The leg cradle frame includes longitudinally spaced inwardly biased first and second frame members for surrounding and retaining an injured leg. The at least one leg member is affixed to the first or second frame members.

### CROSS-REFERENCE TO RELATED APPLICATION

This application claims priority to Provisional Patent Application No. 60/525,035 entitled LOWER LEG CRUTCH, which was filed on Nov. 25, 2003.

### BACKGROUND OF THE INVENTION

The present invention relates to a crutch, and more specifically to a leg crutch.

After incurring a foot or lower leg injury, a patient commonly uses a pair of crutches to retain the mobility of the patient. There are two primary forms of crutches, the traditional crutch and the knee crutch.

Traditional or conventional crutches typically include a pair of legs attached to an upper cross bar or crutch head and a hand grip attached to the legs and positioned between the crutch head and the lower end of the legs. The patient uses the crutch by placing the crutch head under the armpit and grasping the hand grip. The patient generally supports their weight by the combination of grasping the hand grip and resting on the crutch head. However, extended use of these conventional crutches generally results in discomfort to the armpit or rib cage and since these crutches do not typically support the injured leg, the injured leg is also distressed.

To overcome the disadvantage of conventional crutches, the second type of crutch, which is commonly referred to as a lower leg crutch or a knee crutch, has been developed which directly supports the injured leg. In essence, the knee crutch removes the stresses on the injured leg which are developed in the conventional style crutches. However, these crutches have heretofore not adequately supported the injured leg through the entire range of (walking) motion. Additionally, conventional leg crutches are used with strapping to secure the crutch to the patient. Therefore, these crutches are difficult to get into and out of, making their use burdensome.

Accordingly, a lower leg support is desired, having the aforementioned advantages and solving the aforementioned problems.

### SUMMARY OF THE INVENTION

One aspect of the present invention is to provide the lower leg crutch comprising a leg cradle, a leg cradle frame that supports the leg cradle, and at least one leg member. The leg cradle frame includes longitudinally spaced inwardly biased first and second frame members for surrounding and retaining an injured leg. The at least one leg member is affixed to the first or second frame members.

In another aspect of the present invention, the lower leg crutch is provided that includes a leg cradle, a leg cradle frame, and first and second V-shaped legs. The leg cradle frame supports the leg cradle with the leg cradle frame and includes parallel, horizontally spaced first and second frame members. The leg cradle is supported by the first and second frame members. Each of the first V-shaped leg and the second V-shaped leg has a first and a second end, with the first V-shaped leg and the second V-shaped leg being connected at the first end to the first and second frame members, respectively, and with two upper points of the first end of the first V-shaped leg disposed on the first frame member and two upper points of the first end of the second V-shaped leg disposed on the second frame member.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of the leg crutch embodying the present invention.

FIG. 2 is an exploded view of the leg crutch of FIG. 1.

FIG. 3 is a side view of the leg crutch embodying the present invention in use.

FIG. 4 is a front view of a foot member and removable pad of the leg crutch of FIG. 1.

FIGS. 5-8 are side views of the leg crutch of FIG. 1 in various stages of folding.

FIG. 9 is a side view of the leg crutch of FIG. 1 in an enclosure.

FIG. 10 is a perspective view of a leg crutch of a second embodiment of the present invention.

FIG. 11 is an exploded view of the leg crutch of FIG. 10.

FIG. 12 is a side view of the leg crutch of the second embodiment of the present invention in use.

FIG. 13 is a front view of a foot member of the leg crutch of FIG. 10.

FIG. 14 is a rear view of the leg crutch of FIG. 10.

FIGS. 15-16 are side views of the leg crutch of FIG. 10 in various stages of folding.

FIG. 17 is a perspective view of a leg crutch of a second embodiment of the present invention.

### DETAILED DESCRIPTION OF THE PREFERRED EMBODIMENT

In various preferred embodiments, the invention is used to provide a person having a lower leg injury a comfortable, strapless crutch having numerous adjustable parameters, including adjustable feet, which allow the camber or tilt of the crutch to be tailored to the specific requirements of the user.

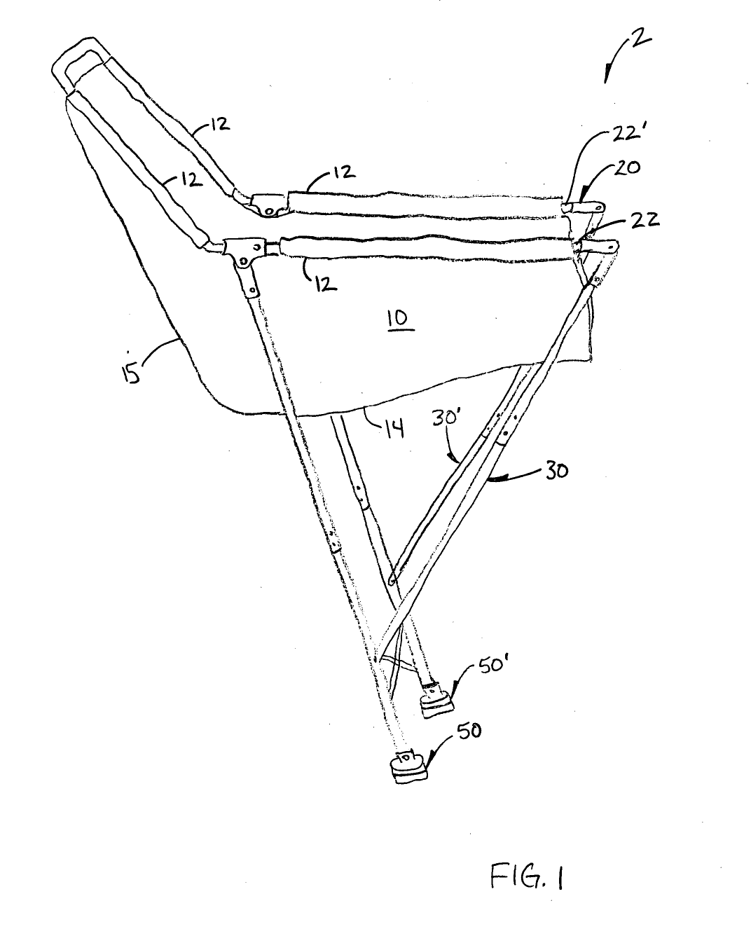

In a first embodiment (FIG. 1), a lower leg crutch 2 includes a leg cradle 10 and a leg cradle frame 20. Leg cradle frame 20 further includes parallel, horizontally spaced first and second frame members 22 and 22′, respectively, for supporting leg cradle 10. A first and second V-shaped leg 30 and 30′ are connected at one end to first and second frame members 22 and 22′, thereby supporting leg cradle 10 in a generally horizontal position. A first and second foot member 50 and 50′ are disposed at a second end of first and second V-shaped legs 30 and 30′, respectively, and are removably attached thereto.

Leg cradle 10 is used to support the injured leg of the user. Cradle 10 includes a leg support section 14 and knee support section 15. Leg cradle 10 consists of a plurality of attachment points, links or unions 12 which are used to support and form leg cradle 10 into a concave leg channel and knee support. In a preferred embodiment, four links are used with a pair of links disposed on each side supporting leg cradle 10 from first and second frame members 22 and 22′ (discussed below) allowing leg cradle 10 to be formed into the aforementioned leg channel and knee support shape.

Leg cradle 10 may be made from a fabric material. This allows leg cradle 10 to be easily collapsed and/or folded. Further, the plurality of links 12 may be fabricated by creating a loop of fabric in which the first and second frame members are disposed, thereby hangingly supporting leg support section 14 and knee support section 15 of the leg cradle. These embodiments are only exemplary and are not meant to be limiting in any manner. Leg cradle 10 may be fabricated from different materials, regardless of whether they are collapsible and foldable. Links 12 may be integrally fabricated out of the material of leg cradle 10 or may be separate elements which are attached to leg cradle 10. Further, the amount and location of the links may also be varied to meet design specifics.

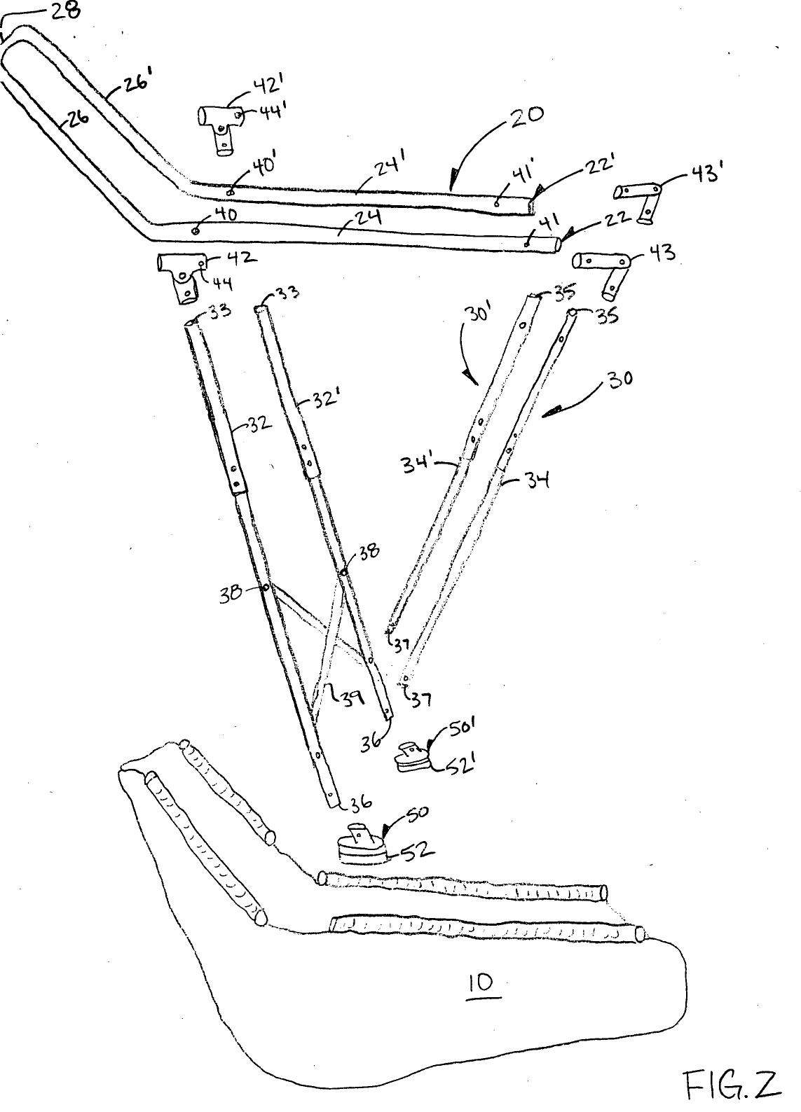

Leg cradle frame 20 includes a first frame member 22 and a second frame member 22′ (FIG. 2). Each frame member 22 and 22′ includes a generally horizontal portion 24 and 24′ and angled portions 26 and 26′, respectively, with both frame members 22 and 22′ being generally parallel. Further, angled portions 26 and 26′ include handle portion 28 which connects angled portions 26 and 26′. In a preferred embodiment, leg cradle frame 20 is fabricated from a lightweight tubular material, for example, aluminum. This is not meant to be limiting in any manner and other geometries and materials may be used.

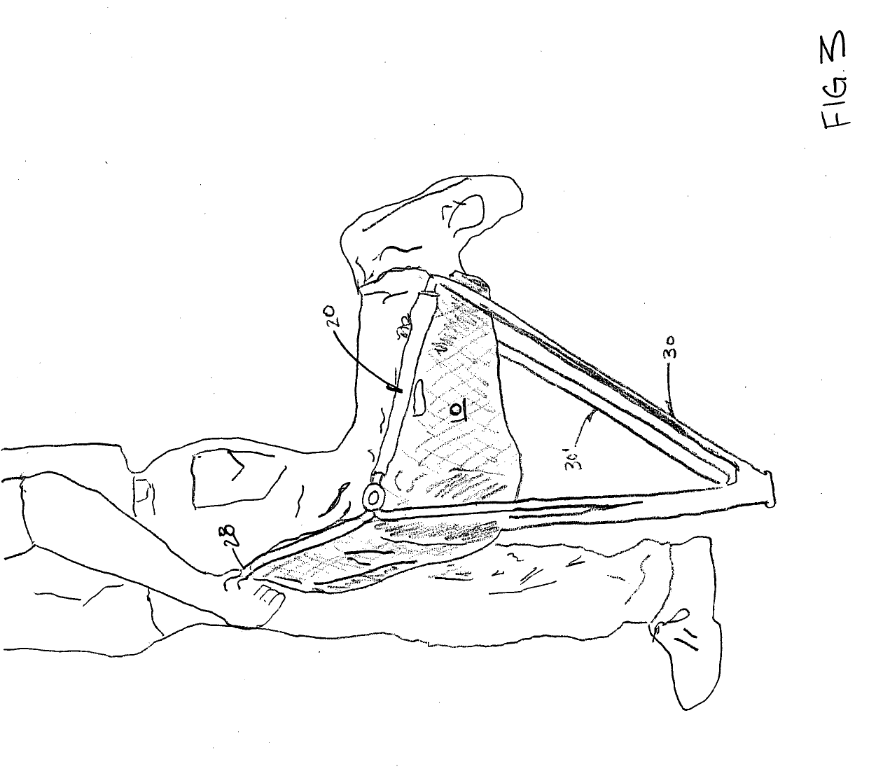

Handle portion 28 is used to provide the patient with a convenient place to grasp the crutch (FIG. 3). This allows the patient a direct manner of facilitating the movement of the crutch as well as provides all of the features and benefits of a walking cane. Additionally, the handle member in conjunction with the angled portions 26 and 26′ act to bias first and second frame members toward one another. This may be accomplished, for example, by utilizing a handle member that is somewhat resilient and having angled portions 26 and 26′, in addition to being angled with respect to frame members 22 and 22′, angled toward one another and thereby biasing them toward one another with handle 28 providing a resiliency to the bias. However, these are only examples and other methods may also be used to create the bias between frame members 22 and 22′ and more particularly, between horizontal portion 24 and 24′.

Biasing horizontal portions 24 and 24′ toward one another allows the patient to use crutch 2 without the need for straps because the biased members act to snugly and securely retain the crutch on the patient's leg in the same way strapping would do. However, by utilizing the bias of horizontal portion 24 and 24′ to retain the patient's leg rather than straps, numerous benefits are accomplished. For example, the speed and ease with which the crutch can be put on and taken off is greatly increased. Further, the comfort is also increased because straps are no longer uncomfortably binding the patient's leg to the crutch. Of course, the crutch could be provided with strapping if the patient so desired.

Leg cradle frame 20 further includes a first pair of protruding biased dimples 40 and 40′ and a second pair of protruding biased dimples 41 and 41′. First biased dimples 40 and 40′ are used to connect a first pair of hinges 42 and 42′ while biased dimples 41 and 41′ are used to connect a second pair of hinges 43 and 43′.

First pair of hinges 42 and 42′ are installed by first sliding hinges 42 and 42′ onto first and second frame members 22 and 22′, respectively. Hinges 42 and 42′ are then retained by biased dimples 40 and 40′. Biased dimples 40, 40′, as well as 41 and 41′, are generally spherical protruding buttons which are spring-loaded into frame members 22 and 22′. This allows the generally spherical button to be recessed with (or co-planar with) frame members 22 and 22′ allowing hinges 42 and 42′ to be slid over biased dimples 40 and 40′. Hinges 42 and 42′ are then secured when dimples 40 and 40′ protrude through apertures 44 and 44′ disposed on hinges 42 and 42′. This manner of attachment is used frequently in medical devices as well as other fields and is well known in the art.

Hinges 43 and 43′ are secured in the same manner as described above with regard to hinges 42 and 42′ and utilize biased dimples 41 and 41′. Together, hinges 42, 42′, 43 and 43′ connect leg members 30 and 30′ to leg cradle frame 20. The aforementioned hinges and biased dimples can be fabricated from various materials and shapes which are not critical to the inventive concept herein. Further, other methods and devices can be used in place of hinges as well as methods of attachment.

Leg members 30 and 30′ are generally V-shaped and include a first leg 30 and a second leg 30′. First leg 30 includes a height adjustable first leg segment 32 and a height adjustable second leg segment 34. The manner of height adjustment is not critical to the inventive concept and can be carried out in ways that are generally well known in the art. Second leg member 30′ includes a corresponding first leg segment 32′ and a corresponding second leg segment 34′. Further, first leg segments 32 and 32′ have a first end 33 whereas second leg segments 34 and 34′ have a first end 35. Correspondingly, first leg segments 32 and 32′ have a second end 36 whereas second leg segments 34 and 34′ have a second end 37.

First leg segments 32 and 32′ have their first ends 33 connected to hinges 42 and 42′ thereby connecting first ends 33 to leg cradle frame 20. Second leg segments 34 and 34′ have their first ends 35 connected to hinges 43 and 43′, thereby connecting second leg segments 34 and 34′ to leg cradle frame 20. The first and second leg segments, as well as all other connections described herein, are connected in a similar manner as described above with regard to mounting the hinges to the leg cradle frame. However, as discussed previously, this is not meant to be limiting and other methods may be used.

Second ends 37 of second leg segments 34 and 34′ are disposed on corresponding first leg segments 32 and 32′ at a location 38 which lies between first ends 33 and second ends 36. As this location approaches second ends 36, the shape of leg members 30 and 30′ is generally V-shaped. However, second ends 37 may be disposed anywhere between first ends 33 and second ends 36. Therefore, as second ends 37 of second leg segments 34 and 34′ are moved away from second ends 36, towards first ends 33, the generally V-shaped leg segments become more Y-shaped. As used herein, “V-shaped” is used to represent the entire range of geometries that first leg 30 and second leg 30′ can form as second ends 37 of second leg segments 34 and 34′ traverse along first leg segments 32 and 32′.

Cross member 39 is affixed to first leg member 30 and second leg member 30′ to increase their rigidity and support. The manner of connection, the placement and the material of cross member 39 can all be varied to meet specific requirements, and are not critical to the inventive concept. Disposed at ends 36 of first and second leg members 32 and 32′ are feet 50 and 50′.

When a person stands in the upright position with their feet touching, the ankle joint is disposed in a position which is generally in line with the leg (fibula). As a person moves their feet outwardly, the ankle joint maintains the entire sole of the foot on the floor by rotating the sole of the foot inward in a movement called inversion. Were it not for the availability of the ankle joint to move in this manner, human beings would become less stable as their feet became separated. Additionally, since people generally walk with their feet separated, the ability of the ankle to rotate inwardly is important for stability. As described herein, the word “camber” will denote this ability of the ankle to angle the foot to increase stability and more specifically to the angle itself. Prior art crutch systems have either failed to provide for this angle or have provided for the camber in an exceedingly complicated and/or expensive manner. Feet 50 and 50′ solve this problem simply and inexpensively.

This is accomplished by providing feet 50 and 50′ with replaceable pad members 52 and 52′ (FIG. 3). FIG. 3 shows foot 50 only, however, foot 50′ would be similar in design. Pad members 52 and 52′ can be fabricated from various materials to meet specific design criteria such as proper wear characteristics and/or resistance to slippage. Additionally, feet 50 and 50′ can be fabricated in various heights to adjust the camber of leg cradle 10, thereby insuring maximum comfort. This is accomplished by using a different height pad member on leg 30 than on leg 30′, creating a slight angle or camber to the crutch.

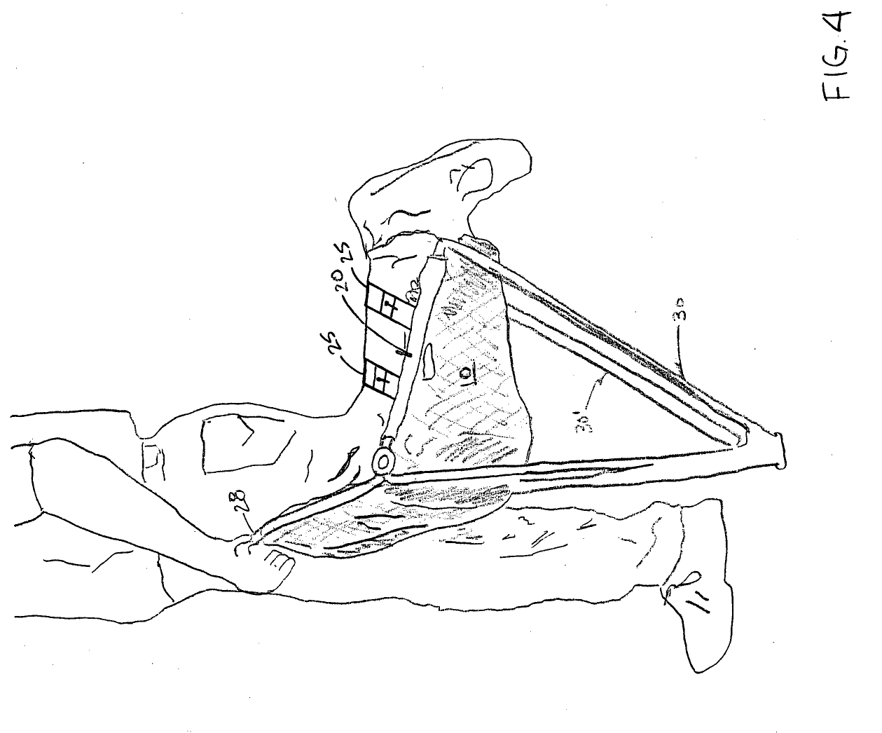

More particularly, as shown in FIG. 4, pad 52 of foot 50 may be designed with a thickness D. Since two pads are used, one on each leg 30 and 30′, by varying the thickness of pads 52 and 52′, the camber or tilt of the crutch can be adjusted. Additionally, these pads can be made in any height, allowing the crutch to be tilted at any angle to allow for maximum flexibility and the specific needs and walking characteristics of the user. Pads 52 and 52′ can be adhered to feet 50 and 50′ by any means which allows for them to remain replaceable. For example, in a preferred embodiment, pads 52 and 52′ are threadingly engaged with feet 50 and 50′ allowing them to be easily affixed, removed and changed. Of course, in addition to the pad height being changed, the pads themselves could be made at an angle if so desired.

In use, first and second frame members 22 and 22′, which are biased towards each other, are separated thereby increasing the distance between first member 22 and second member 22′ to allow for the insertion of the user's knee and lower leg. After insertion of the lower leg, the bias between frame members 22 and 22′ acts to snugly cradle the leg member within leg cradle 10 without the use of straps. This gives the ability of the user to utilize the crutch 2 in a hands free manner, while still allowing for easily and quickly removing crutch member 2. Additionally, handle 28 is provided on crutch member 2 to provide for stability and retention when the circumstances require.

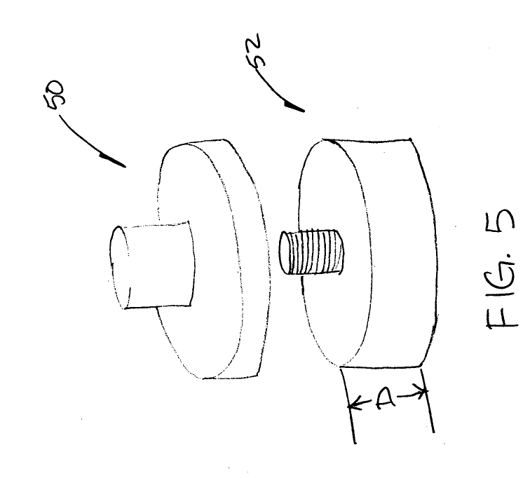

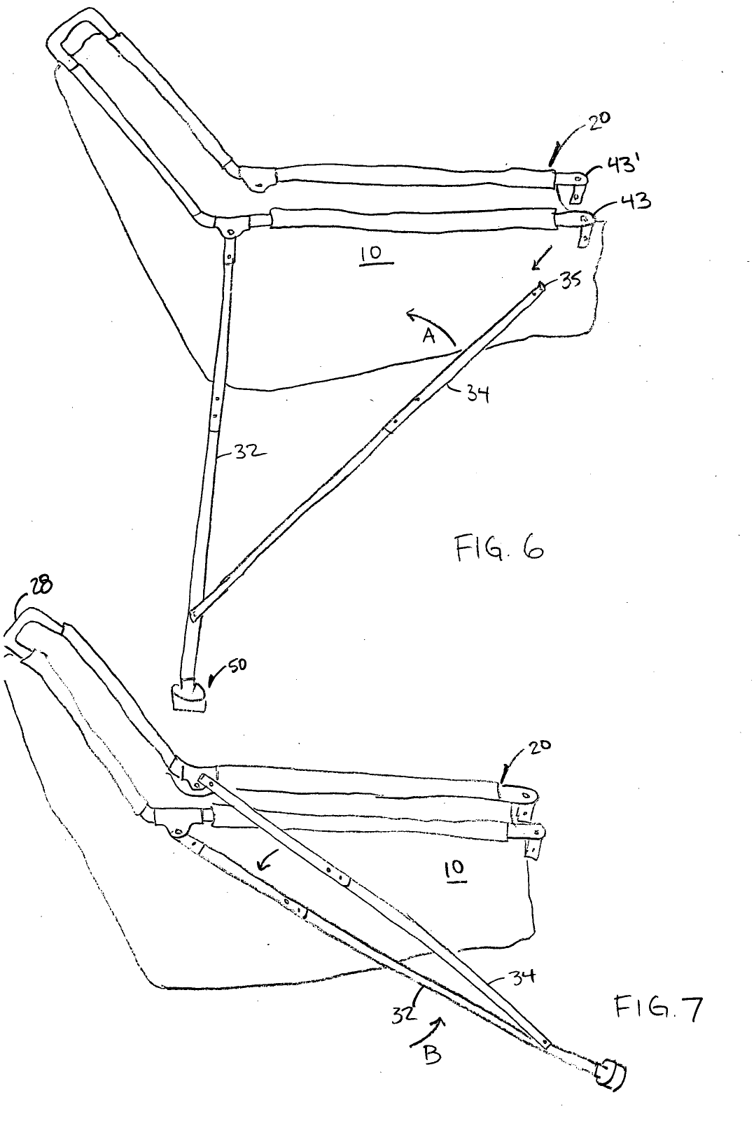

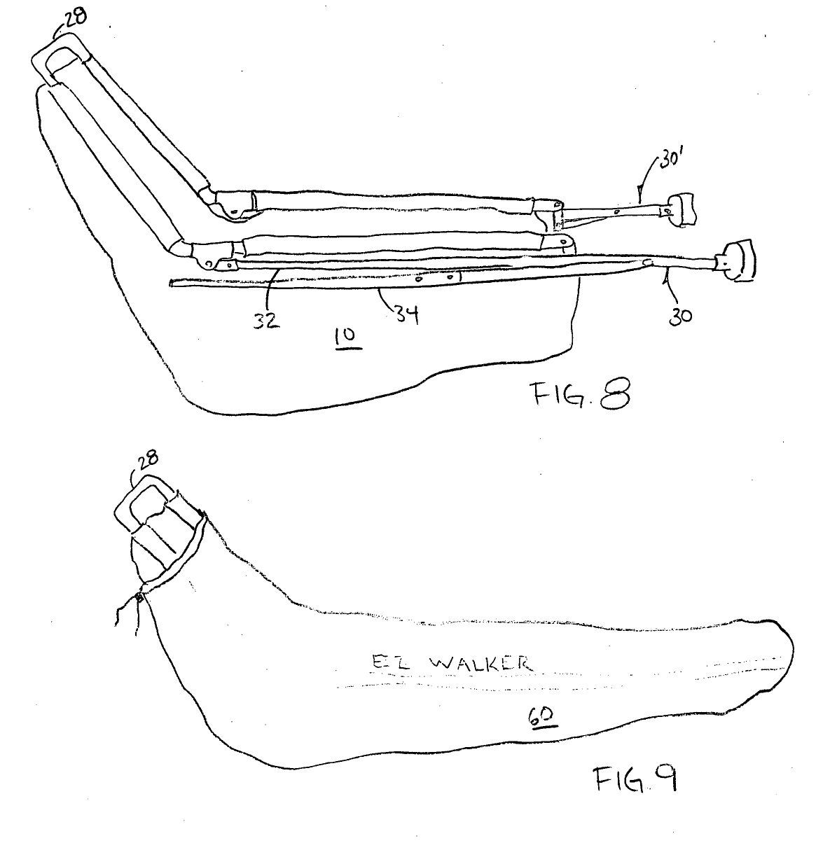

When the crutch is done being used, crutch member 2 may be easily and quickly folded for storage. One manner of folding crutch member 2 is as follows. Firstly, separate first ends 35 of second leg segments 34 and 34′ from hinges 43 and 43′ disposed on leg cradle frame 20 (FIG. 5). Second leg segments 34 and 34′ are then rotated in a direction A, towards first leg segments 32 and 32′. Thereafter, first leg segments 32 and 32′ are rotated in a direction B, upwardly towards leg cradle frame 20, until the first and second leg 30 and 30′ are relatively coplanar with the horizontal portions of leg cradle frame 20 (FIGS. 6 and 7). Finally, lower leg crutch 2 may be easily stored within a bag or other enclosure 60 for storage (FIG. 8). Additionally, it is envisioned that angled portions 26 and 26′ could also be hinged to first and second frame members 22 and 22′ (not shown), thereby allowing handle 28 to be folded into a somewhat coplanar relationship with first and second frame member 22 and 22′ for further reduction in size.

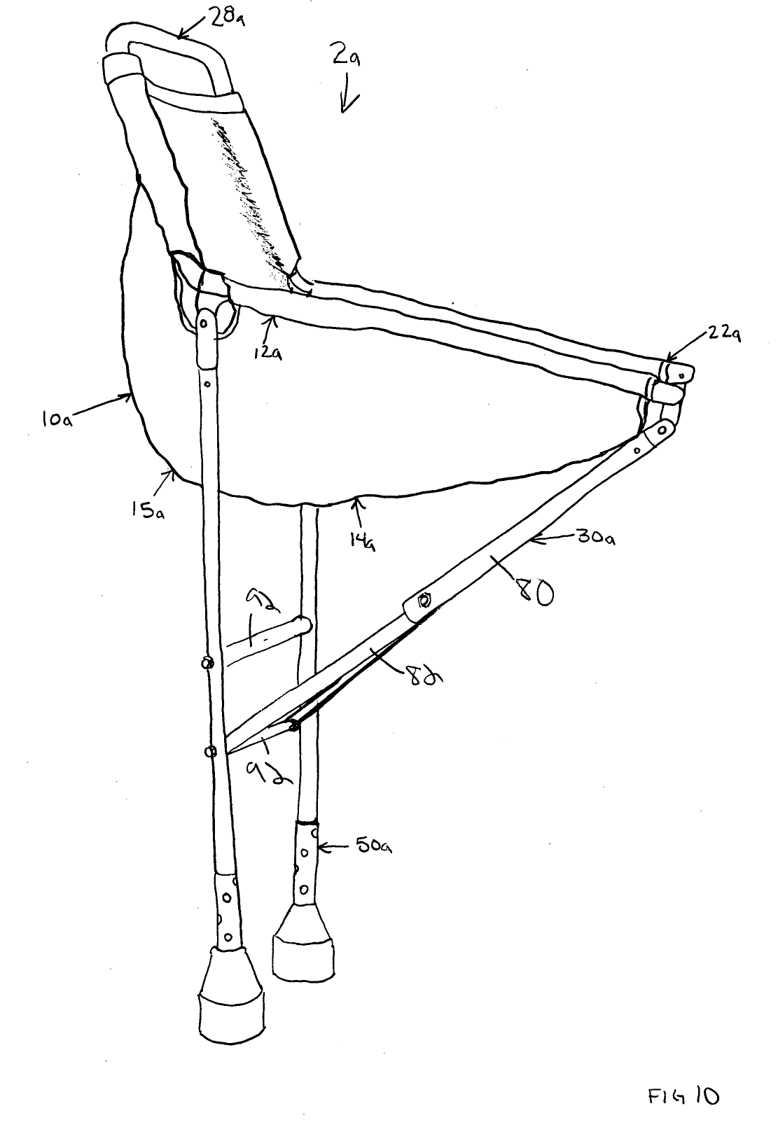

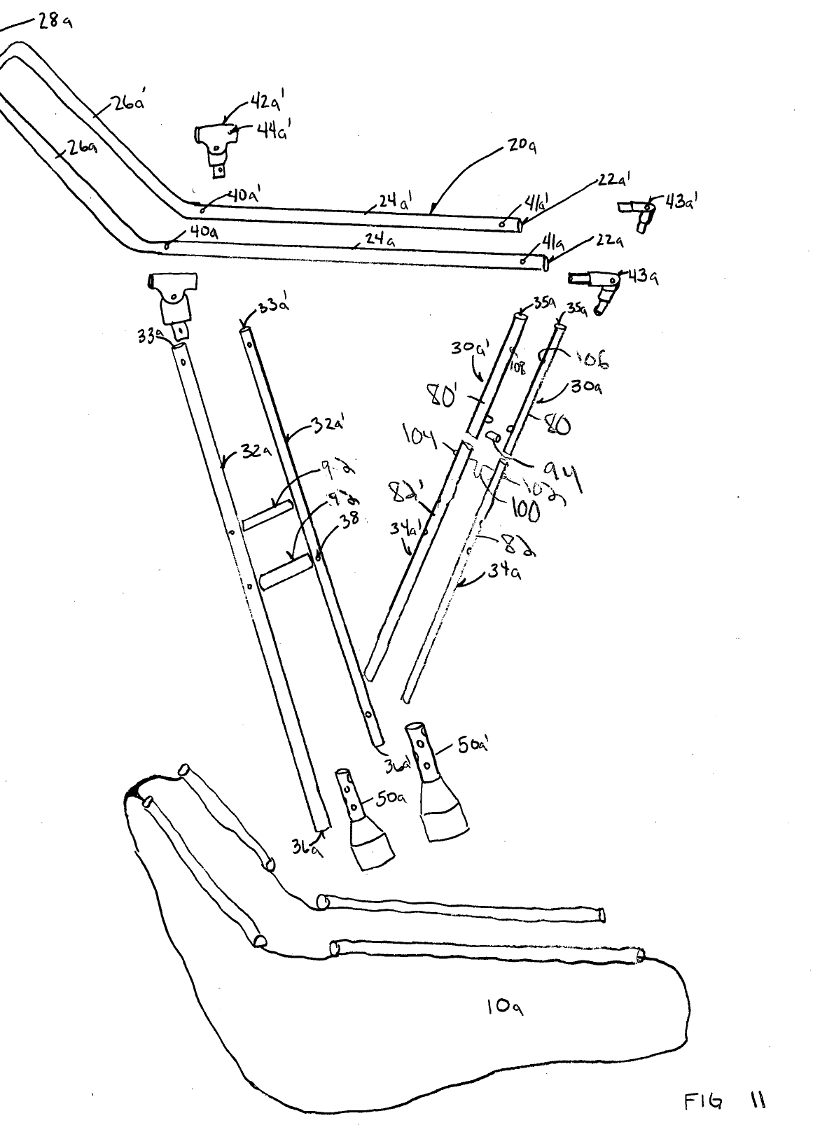

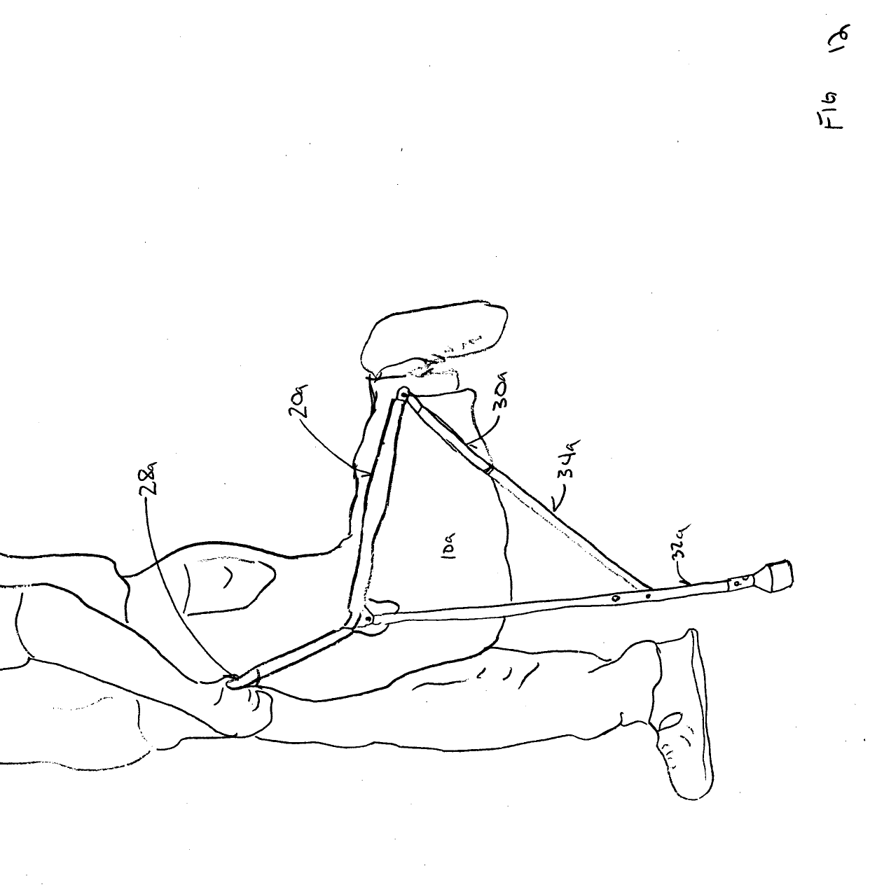

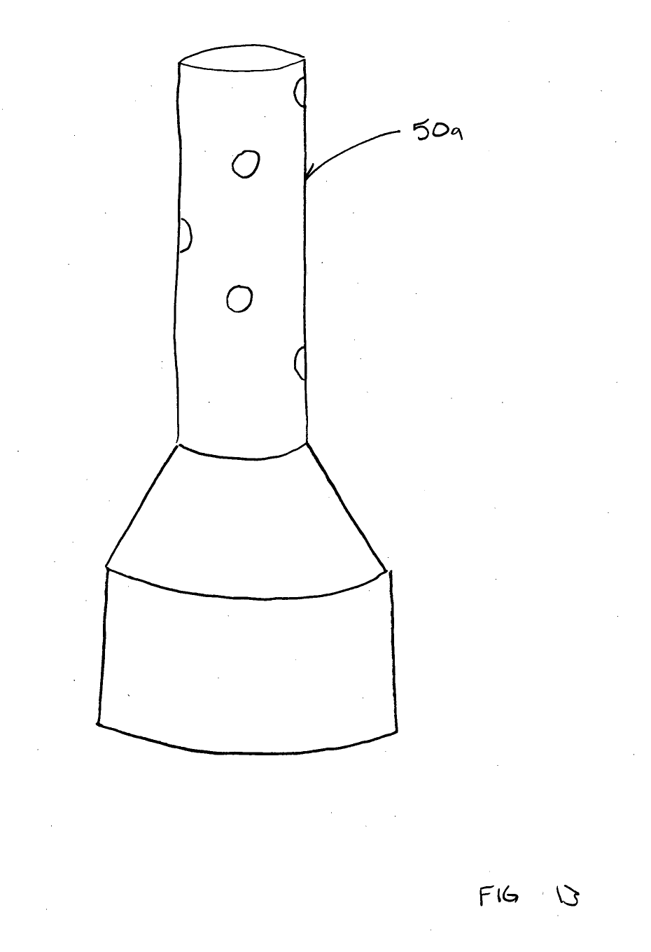

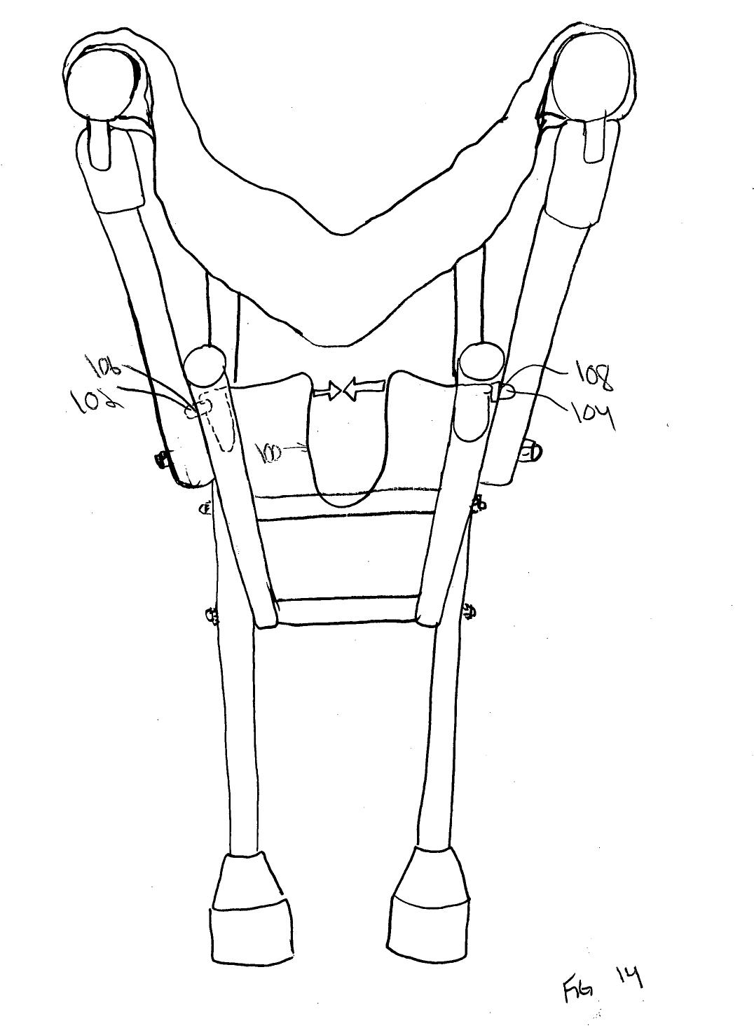

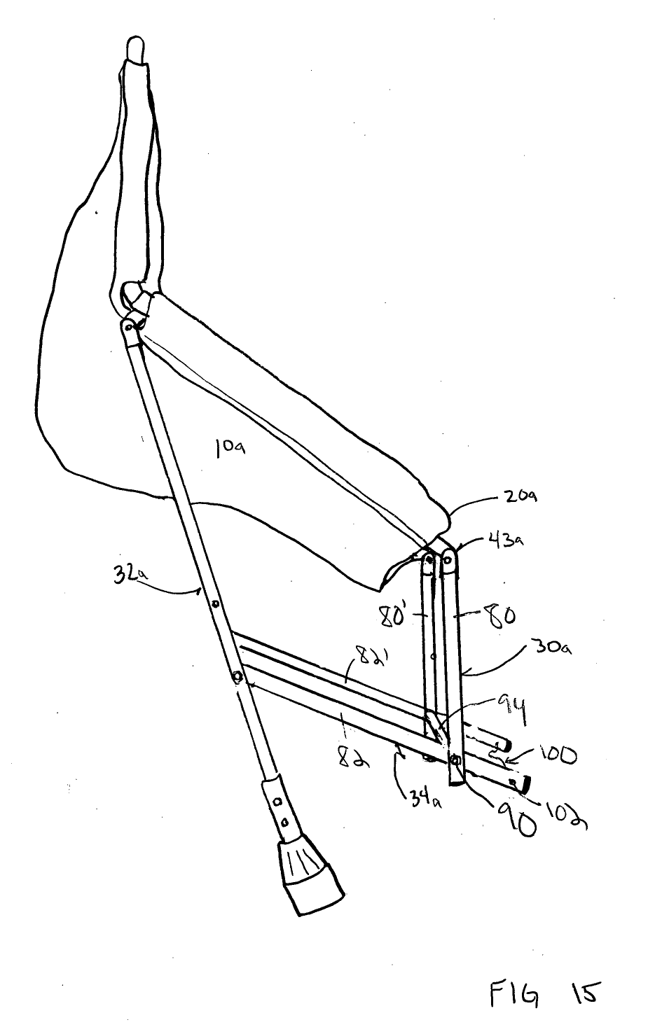

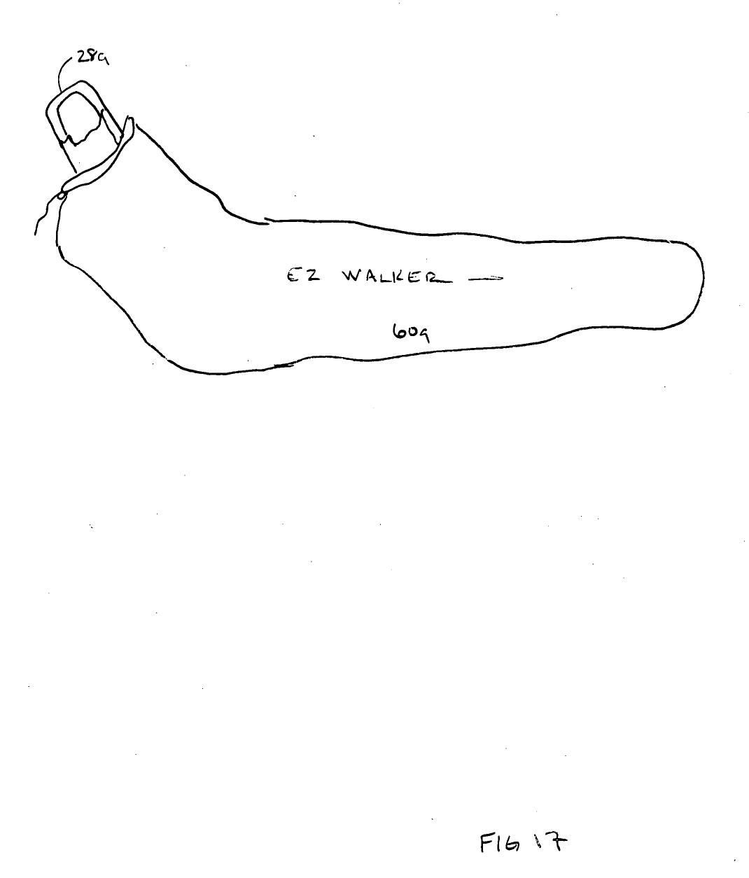

The reference numeral 2a (FIGS. 10-17) generally designates another embodiment of the present invention, having a second embodiment for the lower leg crutch. Since lower leg crutch 2a is similar to the previously described lower leg crutch 2, similar parts appearing in FIGS. 1-9 and FIGS. 10-17, respectively, are represented by the same, corresponding reference number, except for the suffix “a” in the numerals of the latter. The second lower leg crutch 2a is identical to the first embodiment of the lower leg crutch 2 and includes all of the options as discussed above, except for the first V-shaped leg 30a, the second V-shaped leg 30a′, the first foot member 50a and the second foot member 50a′.

In the illustrated example, the first V-shaped leg 30a includes the first leg segment 32a and the second leg segment 34a. The first leg segment 32a is not illustrated as being height adjustable. However, it is contemplated that the first leg segment 32a could be adjustable. The second leg segment 34a includes an upper second leg segment portion 80 and a lower second leg segment portion 82. The upper second leg segment portion 80 is connected to the hinge 43a and the lower second leg segment portion 82 is pivotally connected to the first leg segment 32a. Likewise, the second V-shaped leg 30a′ includes the first leg segment 32a′ and the second leg segment 34a′. The first leg segment 32a′ is not illustrated as being height adjustable. However, it is contemplated that the first leg segment 32a′ could be adjustable. The second leg segment 34a′ includes an upper second leg segment portion 80′ and a lower second leg segment portion 82′. The upper second leg segment portion 80′ is connected to the hinge 43a′ and the lower second leg segment portion 82′ is pivotally connected to the first leg segment 32a′.

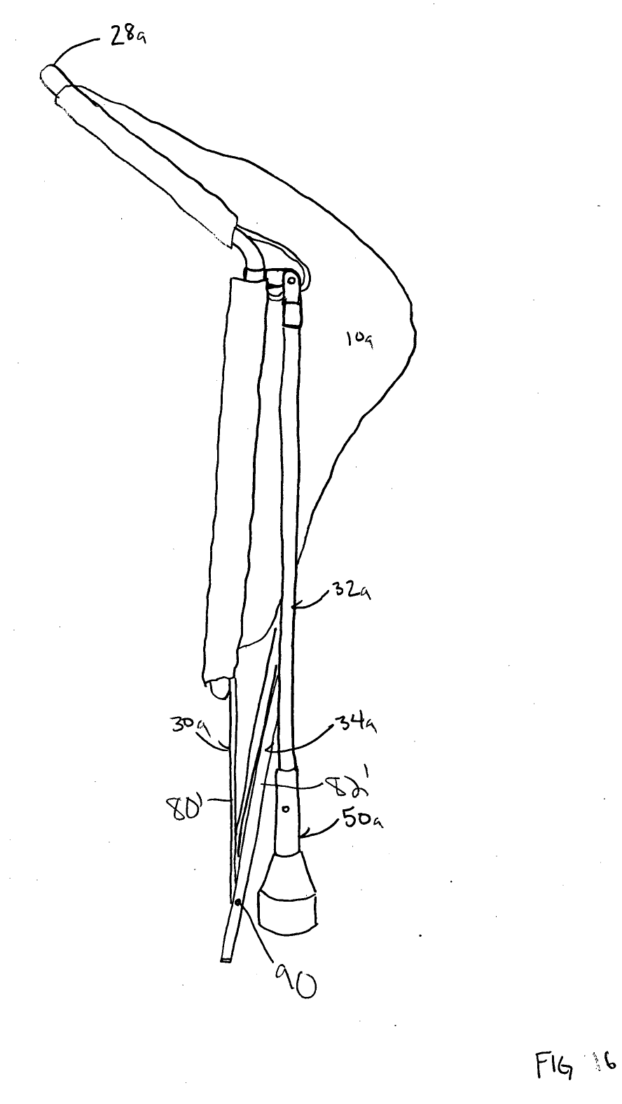

The illustrated first V-shaped leg 30a and the second V-shaped leg 30′ are configured to fold up in order to store the lower leg crutch 2a. The upper second leg segment portion 80 and the lower second leg segment portion 82 of the first V-shaped leg 30a are pivotally connected at a pivot point 90, thereby allowing the upper second leg segment portion 80 and the lower second leg segment portion 82 to be folded relative to each other as illustrated in FIG. 15. Likewise, the upper second leg segment portion 80′ and the lower second leg segment portion 82′ of the second V-shaped leg 30a′ are pivotally connected at a pivot point 90′, thereby allowing the upper second leg segment portion 80′ and the lower second leg segment portion 82′ to be folded relative to each other as illustrated in FIG. 15. A pair of cross members 92 extend between the first leg segment 32a of the first V-shaped leg 30a and the first leg segment 32a′ of the second V-shaped leg 30a′. Furthermore, a cross member 94 extends between the upper second leg segment portion 80 of the second leg segment 34a of the first V-shaped leg 30a and the upper second leg segment portion 80′ of the second leg segment 34a′ of the second V-shaped leg 30a′. The cross members 92 and 94 provide stability for the first V-shaped leg 30a and the second V-shaped leg 30′ and allow the first V-shaped leg 30a and the second V-shaped leg 30′ to be collapsed and opened in unison.

In the illustrated example, the lower leg crutch 2a is stored by collapsing the first V-shaped leg 30a and the second V-shaped leg 30′. In order to collapse the lower leg crutch 2a, the upper second leg segment portion 80 of the second leg segment 34a of the first V-shaped leg 30a and the upper second leg segment portion 80′ of the second leg segment 34a′ of the second V-shaped leg 30a′ are rotated towards a position aligned with the first frame member 22a and the second frame member 22a′, respectively. Furthermore, the lower second leg segment portion 82 of the second leg segment 34a of the first V-shaped leg 30a and the lower second leg segment portion 82′ of the second leg segment 34a′ of the second V-shaped leg 30a′ are rotated towards a position aligned with the first leg segment 32a and the second leg segment 32a′, respectively. In the totally collapsed position, the upper second leg segment portion 80 of the second leg segment 34a of the first V-shaped leg 30a and the upper second leg segment portion 80′ of the second leg segment 34a′ of the second V-shaped leg 30a′ are substantially aligned with the first frame member 22a and the second frame member 22a′, respectively. Furthermore, the lower second leg segment portion 82 of the second leg segment 34a of the first V-shaped leg 30a and the lower second leg segment portion 82′ of the second leg segment 34a′ of the second V-shaped leg 30a′ are substantially aligned with the first leg segment 32a and the second leg segment 32a′, respectively. Therefore, the lower leg crutch 2a can easily be slid into the enclosure 60a.

The illustrated lower leg crutch 2a includes a U-shaped spring member 100 that selectively allows the upper second leg segment portion 80 of the second leg segment 34a of the first V-shaped leg 30a to pivot about the lower leg segment portion 82 and the upper second leg segment portion 80′ of the second leg segment 34a′ of the second V-shaped leg 30a′ to pivot about the lower leg segment portion 82′. The U-shaped spring member 100 includes a first end 102 that extends through a first pair of aligned openings 104 in the upper second leg segment portion 80 and the lower second leg segment portion 82 and a second end 106 that extends through a second pair of aligned openings 104′ in the upper second leg segment portion 80′ and the lower second leg segment portion 82′. The U-shaped spring member 100 includes a U-shaped center portion 108 between the first end 102 and the second end 106.

To allow the lower leg crutch 2a to be moved to the collapsed position for storage, the U-shaped center portion 108 of the U-shaped spring member 100 is compressed until the first end 102 is withdrawn from the opening 104 in the upper second leg segment portion 80 and the second end 106 is withdrawn from the opening 104 in the upper second leg segment portion 80′. Thereafter, the upper second leg segment portion 80 of the second leg segment 34a of the first V-shaped leg 30a is pivoted about the lower leg segment portion 82 and the upper second leg segment portion 80′ of the second leg segment 34a′ of the second V-shaped leg 30a′ is pivoted about the lower leg segment portion 82′ to move the lower leg crutch 2a into the collapsed position for storage. To deploy the lower leg crutch 2a, the upper second leg segment portion 80 of the second leg segment 34a of the first V-shaped leg 30a is pivoted to be in line with the lower leg segment portion 82 and the upper second leg segment portion 80′ of the second leg segment 34a′ of the second V-shaped leg 30a′ is pivoted to be in line with the lower leg segment portion 82′. Once the upper second leg segment portion 80 is aligned with the lower leg segment portion 82 and the upper second leg segment portion 80′ is aligned with the lower leg segment portion 82′, the first end 102 of the U-shaped spring member 100 will be inserted into the opening 104 in the upper second leg segment portion 80 and the second end 106 of the U-shaped spring member 100 will be inserted into the opening 104 in the upper second leg segment portion 80′. Thereafter, the lower leg crutch 2a can be used to support the lower leg of a person.

In the illustrated example, the lower leg crutch 2a includes a foot member 50a at a lower end of the first leg segment 32a and a foot member 50a′ at a lower end of the first leg segment 32a′. The foot member 50a and the foot member 50a′ are preferably elastic to work as a shock absorber for the lower leg crutch 2a and are vertically adjustable relative to the first leg segment 32a and the first leg segment 32a′ to allow a height of the lower leg crutch 2a to be adjustable.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A lower leg crutch comprising:
a leg cradle;
a leg cradle frame supporting the leg cradle, the leg cradle frame including longitudinally spaced inwardly biased first and second frame members for surrounding and retaining an injured leg; and
at least one leg member affixed to the first or second frame members.

2. The crutch of claim 1, further including:
at least one foot member affixed to the at least one leg member.

3. The crutch of claim 2, wherein:
the at least one foot member includes at least one removable pad member attached to the at least one foot member.

4. The crutch of claim 2, wherein:
the at least one foot member is vertically adjustable on the at least one leg member.

5. The crutch of claim 1, wherein:
the at least one leg member includes a first V-shaped leg and a second V-shaped leg, each of the first V-shaped leg and the second V-shaped leg having a first and a second end, the first V-shaped leg and the second V-shaped leg being connected at the first end to the first and second frame members, with two upper points of the first end of the first V-shaped leg disposed on the first frame member and two upper points of the first end of the second V-shaped leg disposed on the second frame member.

6. The crutch of claim 5, further including:
a first and a second foot member removably attached to the second ends of the first and the second legs, respectively.

7. The crutch of claim 6, wherein:
a first and a second removable pad member are attached to the first and the second foot members, respectively.

8. The crutch of claim 6, wherein:
the first foot member and the second foot member are vertically adjustable on the first leg and the second leg, respectively.

9. The crutch of claim 7, wherein:
the first and the second removable pad members have a first and a second thickness, respectively, the first thickness being different from the second thickness.

10. The crutch of claim 5, further including:
a cross member connecting the first and the second V-shaped legs.

11. The crutch of claim 5, wherein:
the leg cradle is collapsible.

12. The crutch of claim 5, further including:
straps disposed on the leg cradle for securing an injured leg thereto.

13. The crutch of claim 5, wherein:
the first and second frame members are horizontally spaced and are biased towards one another.

14. The crutch of claim 1, wherein:
the at least one leg member comprises first and second V-shaped legs that rotate parallel to the first and second frame members, thereby collapsing the crutch to a collapsed position for storage.

15. The crutch of claim 14, further including:
a carrying bag for storing the crutch in the collapsed position.

16. The crutch of claim 1, wherein:
the at least one leg member comprises a first leg member and a second leg member; and
the first leg member and the second leg member are foldable to allow the crutch to be moved into a collapsed position for storage.

17. A lower leg crutch comprising:
a leg cradle;
a leg cradle frame supporting the leg cradle, the leg cradle frame including parallel, horizontally spaced first and second frame members, the leg cradle being supported by the first and second frame members; and
a first and a second V-shaped leg, each of the first V-shaped leg and the second V-shaped leg having a first and a second end, the first V-shaped leg and the second V-shaped leg being connected at the first end to the first and second frame members, respectively, with two upper points of the first end of the first V-shaped leg disposed on the first frame member and two upper points of the first end of the second V-shaped leg disposed on the second frame member.

18. The crutch of claim 17, further including:
a first and a second foot member removably attached to the second end of the first and the second legs, respectively.

19. The crutch of claim 18, wherein:
a first and a second removable pad member are attached to the first and the second foot members, respectively.

20. The crutch of claim 19, wherein:
the first and the second removable pad members have a first and a second thickness, respectively, the first thickness being different from the second thickness.

21. The crutch of claim 18, wherein:
the first foot member and the second foot member are vertically adjustable on the first leg and the second leg, respectively.

22. The crutch of claim 17, further including:
a cross member connecting the first and the second V-shaped legs.

23. The crutch of claim 17, wherein:
the leg cradle is collapsible.

24. The crutch of claim 17, further including:
straps disposed on the leg cradle for securing an injured leg thereto.

25. The crutch of claim 17, wherein:
the first and second V-shaped legs are rotatably connected to the first and second frame members, thereby allowing the crutch to move to a collapsed position for storage.

26. The crutch of claim 25, further including:
a carrying bag for storing of the crutch in the collapsed position.

27. The crutch of claim 17, wherein:
the first and second frame members are horizontally spaced and are biased towards one another.

28. The crutch of claim 17, wherein:
the first V-shaped leg and the second V-shaped leg are foldable to allow the crutch to be moved into a collapsed position for storage.
